(19) United States
(12) Patent Application Publication
(10) Pub. No.: US 2019/0367714 A1
(43) Pub. Date: Dec. 5, 2019

(54) FLEXIBLE, FIREPROOF THERMOPLASTIC COMPOSITIONS WITH HIGH THERMOMECHANICAL STRENGTH AND IMPROVED THERMAL AGEING

(71) Applicant: Arkema France, Colombes (FR)

(72) Inventors: Jean-Jacques FLAT, Goupillieres (FR); Mathieu SABARD, Serquigny (FR); Dominique JOUSSET, Bougival (FR); David MESLET, Bernay (FR); Regis CIPRIANI, Tournedos Bois Hubert (FR)

(73) Assignee: Arkema France, Colombes (FR)

(21) Appl. No.: 16/480,000

(22) PCT Filed: Jan. 26, 2018
(86) PCT No.: PCT/FR2018/050179

§ 371 Date: Jul. 23, 2019

(30) Foreign Application Priority Data
Jan. 27, 2017 (FR) 1750697

(51) Int. Cl. C08L 23/08; C08K 5/00; C08K 5/52; C08L 77/00

(52) U.S. Cl. CPC C08L 23/0869; C08K 5/0066; C08K 5/52; C08L 2203/202; C08L 2201/02; C08L 2203/206; C08L 77/00

(57) ABSTRACT

The present invention relates to compositions comprising a copolymer comprising at least one segment of a polyolefin and at least one segment of a polyamide, said composition additionally comprising piperazine pyrophosphate and, if appropriate, a coloring additive. The present invention also relates to a method for the manufacture of these compositions and to the use of the latter in the manufacture of jacket for metal cables, of electrical parts, such as electrical connectors or electrical engineering housings, of thermal protection jackets or sleeves, of injection-molded parts for electronic equipment, such as computers and telephones, of monolayer or multilayer tubes or of bellow tubes, preferably in the manufacture of jacket for metal cables. Finally, it also relates to the electronic, electrical or thermal protection components comprising said composition.

The present invention relates to flexible thermoplastic flame-retardant compositions having high thermomechanical strength, based on polyolefins and on polyamides containing at least one flame retardant and a coloring additive. The present invention also relates to the use of such a composition and to a process for the preparation of this composition.

Thermoplastic polymers, such as polyethylenes, polyamides or their mixtures, are good electrical insulators and are easy to process. They are used in particular to produce electrical housings and connectors and also cable jackets. Electrical installations can be the cause of short circuits and can catch fire; they may also be brought into contact with a flame and thus catch fire and propagate the fire along the cable trays. There exist different additives for rendering these substances nonflammable, some based on halogenated products, and others devoid of halogens. However, the use of halogenated additives is increasingly restricted for reasons of ecotoxicology and toxicology (toxicity and corrosiveness of the vapors emitted during fires).

Furthermore, the performance qualities of resistance to fire of these compositions of the prior art are generally obtained to the detriment of the ductility of the materials (considerable loss in elongation at break, brittle nature under impact at ambient temperature). Furthermore, it is found that the thermal stability of these materials was inadequate. Thermal stability is understood to mean the preservation of the mechanical properties (more particularly the elongation at break) after various thermal agings (for example one week at 120° C. under hot air).

The document WO 2007/141449 provides compositions based on functionalized polyolefins grafted by polyamides, rendered flame retardant without halogen, which make it possible to produce a material which is effective in terms of resistance to flame propagation (according to the UL94 test), also having mechanical and thermomechanical properties of a good standard and also a good thermal stability and a satisfactory rheology (no excessive viscosifying, high MFI (Melt Flow Index)), without producing exudation on the materials obtained.

Furthermore, it is known to color thermoplastic compositions, so as to be able, for example, to distinguish the cables according to their section or number of conductors.

In fact, the compositions described above exhibit a disadvantage in that the materials darken over time. Thus, in the case of colored cables, the different colorations of cables can no longer be told apart.

Surprisingly, the applicant company has demonstrated that the use of a specific flame retardant, piperazine pyrophosphate, makes it possible to avoid the problem of darkening over time, while retaining noteworthy mechanical, thermomechanical, rheological and flame retardancy performance qualities.

The present invention thus relates to a composition comprising:
a copolymer comprising at least one segment of a polyolefin and at least one segment of a polyamide,
piperazine pyrophosphate,
a coloring additive, if appropriate, and optionally
a molecular sieve.

Preferably, the present invention relates to a composition comprising:
a copolymer comprising at least one segment of a polyolefin and, on average, at least one segment of a polyamide attached to said polyolefin by the residues of at least one unsaturated monomer (X),
piperazine pyrophosphate,
a coloring additive, if appropriate, and
optionally a molecular sieve.

Preferably, said composition is a flame-retardant composition, preferably a flexible thermoplastic flame-retardant composition.

“Flexible thermoplastic” is understood to mean a composition exhibiting a flexural modulus of less than or equal to 600 MPa, at ambient temperature, and an elastic modulus value, measured by dynamic mechanical analysis (DMA), of at least 0.5 MPa at 150° C.

The dynamic mechanical analysis (DMA) consists in stressing the material to be analyzed in dynamic tension (1 Hz) over a temperature range from −100° C. up to 250° C. at a heating rate of 2° C./min and in recording the values of the elastic and loss moduli and also their ratio, corresponding to the tangent of the loss angle.

The composition according to the present invention exhibits a high thermal stability.

It is considered that the composition exhibits a satisfactory thermal stability when it retains of the order of 70% of its initial mechanical properties of elongation at break and of breaking stress after aging under thermal oxidation conditions.

The rheology of the composition is regarded as satisfactory when it is compatible with the common processes for the transformation of materials starting from the compositions according to the invention (extrusion, injection molding, and the like).

Preferably, said composition does not comprise a halogenated compound.

Preferably, the composition according to the present invention comprises from 50% to 70%, preferably from 55% to 65% and particularly preferably approximately 60% by weight of said copolymer, with respect to the total weight of the composition.

Preferably, the composition according to the present invention comprises from 5% to 50%, preferably from 10% to 40% and particularly preferably from 10% to 30% by weight of said piperazine phosphate, with respect to the total weight of the composition. According to a preferred embodiment, the composition comprises from 5% to 20% and very particularly from 10% to 15% by weight of said piperazine phosphate, with respect to the total weight of the composition. This is because it has been found that, surprisingly, a satisfactory flame-retardant effect can be obtained with an amount of flame retardant markedly less than that generally recommended. Thus, the behavior towards fire of an uncolored thermoplastic composition comprising 12.5% by weight of piperazine pyrophosphate makes it possible to successfully pass the fire-on-cable test.

The composition according to the invention may or may not comprise a coloring additive. Consequently, the composition according to the present invention can be colored or uncolored. When it is colored, the composition according to the present invention preferably comprises from 0.1% to 5%, preferably from 0.5% to 2% and particularly preferably approximately 1% by weight of coloring additive, with respect to the total weight of the composition.

Preferably, the composition according to the present invention comprises from 0.1% to 5%, preferably from 0.5% to 3% and particularly preferably approximately 2% by weight of molecular sieve, with respect to the total weight of the composition.

According to a preferred form, the present invention relates to a composition comprising:
from 50% to 70% by weight of said copolymer comprising at least one segment of a polyolefin and at least one segment of a polyamide, with respect to the total weight of the composition,
from 3% to 40% by weight of piperazine pyrophosphate, with respect to the total weight of the composition,
if appropriate, from 0.1% to 5% by weight of coloring additive, with respect to the total weight of the composition, and
optionally a molecular sieve.

Preferably, said copolymer comprises, on average, at least 1.3 mol of residues of the unsaturated monomer (X) attached to the at least one polyolefin segment per mole of polyolefin segment and preferably, on average, less than 20 mol of residues of the unsaturated monomer (X) attached to the at least one polyolefin segment per mole of polyolefin segment. Particularly preferably, said copolymer comprises, on average, between 3 and 5 mol of residues of the unsaturated monomer (X) attached to the at least one polyolefin segment per mole of polyolefin segment.

A person skilled in the art can easily determine, by FTIR analysis, the number of moles of X. For example, if X is maleic anhydride and the molecular weight of the polyolefin is 95 000 g/mol, it has been found that this corresponded to a proportion of anhydride of at least 1.5% by weight of the whole of the X-containing polyolefin segment and preferably from 2.5% to 4%. These values associated with the weight of the polyamides determine the proportion of polyamide and of polyolefin in the copolymer.

Preferably, the copolymers of the present invention are characterized by a nanostructured arrangement with polyamide sheets with a thickness of between 5 and 100 nanometers, preferably between 10 and 50 nanometers.

Advantageously, the polyolefin/polyamide ratio by weight in the copolymer as defined above is between 90:10 and 50:50, preferably between 80:20 and 70:30.

Said unsaturated monomer X can, for example, be an unsaturated epoxide, a (meth)acrylic acid or an unsaturated carboxylic acid anhydride.

The unsaturated carboxylic acid anhydride can be chosen, for example, from the group consisting of: a maleic, itaconic, citraconic, allylsuccinic, cyclohex-4-ene-1,2-dicarboxylic, 4-methylenecyclohex-4-ene-1,2-dicarboxylic, bicyclo[2.2.1]hept-5-ene-2,3-dicarboxylic and x-methylbicyclo[2.2.1]hept-5-ene-2,2-dicarboxylic anhydride. Preferably, said unsaturated carboxylic acid anhydride is maleic anhydride.

“Polyolefin” or “polyolefin segment” is understood to mean a polymer comprising a comonomer chosen from the group consisting of:
α-olefins, advantageously those having from 3 to 30 carbon atoms.
   Advantageously, said α-olefin can be chosen from the group consisting of ethylene, propylene, 1-butene, 1-pentene, 3-methyl-1-butene, 1-hexene, 4-methyl-1-pentene, 3-methyl-1-pentene, 1-octene, 1-decene, 1-dodecene, 1-tetradecene, 1-hexadecene, 1-octadecene, 1-icosene, 1-docosene, 1-tetracosene, 1-hexacosene, 1-octacosene and 1-triacontene, preferably propylene or ethylene, particularly preferably ethylene;
esters of unsaturated carboxylic acids, such as, for example, alkyl acrylates or alkyl methacrylates, said alkyls preferably having from 1 to 24 carbon atoms; examples of alkyl acrylate or methacrylate are in particular methyl methacrylate, ethyl acrylate, n-butyl acrylate, isobutyl acrylate or 2-ethylhexyl acrylate;
vinyl esters of saturated carboxylic acids, such as, for example, vinyl acetate or vinyl propionate;
dienes, such as, for example, butadiene, isoprene or 1,4-hexadiene;
and mixtures of these.
   By way of example, said polyolefin segment can be chosen from the group consisting of:
polyethylene homopolymers and heteropolymers, in particular chosen from the group consisting of: low-density polyethylenes (LDPE), high-density polyethylenes (HDPE), linear low-density polyethylenes (LLDPE), very low density polyethylene (VLDPE) and metallocene polyethylene;
propylene homopolymers and heteropolymers;
ethylene/α-olefin polymers, such as ethylene/propylene, ethylene/butylene, ethylene/propylene/diene monomer or ethylene/octene, alone or as a mixture with a PE;
styrene/ethylene-butene/styrene (SEB S), styrene/butadiene/styrene (SBS), styrene/isoprene/styrene (SIS) or styrene/ethylene-propylene/styrene (SEPS) block polymers;
polymers of ethylene with at least one product chosen from the salts or the esters of unsaturated carboxylic acids, such as alkyl (meth)acrylate (for example methyl acrylate), or vinyl esters of saturated carboxylic acids, such as vinyl acetate;
ethylene/maleic anhydride and ethylene/alkyl (meth)acrylate/maleic anhydride polymers.

The preferred segments of polyolefins consist of an ethylene/alkyl (meth)acrylate polymer. By using this polyolefin, an excellent resistance to aging due to light and to temperature is obtained.

Preferably, the proportion of α-olefin is less than 60% by weight, preferably between 2% and 40% by weight, of said copolymer and particularly preferably from 15% to 35% by weight of said copolymer.

Advantageously, said polyethylene segment is a mixture of several polymers; preferably, it comprises at least 50% and preferably 75% (by moles) of ethylene, with respect to said mixture.

Preferably, when the polyolefin segment comprises α-olefins, the proportion of α-olefin is less than 60% by weight, preferably between 2% and 40% by weight, of said polyolefin/polyamide copolymer and particularly preferably from 15% to 35% by weight of said copolymer.

Preferably, said ethylene/maleic anhydride and ethylene/alkyl (meth)acrylate/maleic anhydride polymers comprise from 0.2% to 10% by weight of maleic anhydride, with respect to the total weight of said polymer.

Preferably, said segments of ethylene/alkyl (meth)acrylate/maleic anhydride polymers comprise from 0% to 50%, preferably from 2% to 40% and more preferably from 5% to 30% by weight of alkyl (meth)acrylate.

Preferably, said at least one polyolefin segment exhibits a viscosity index (Melt Flow Index (MFI)) of between 3 and 1000 g/10 min, preferably between 20 and 400 g/10 min (190° C., 2.16 kg, ASTM D 1238).

Preferably, said at least one polyolefin segment has a density of between 0.86 and 0.98 g/cm³, more preferably between 0.90 and 0.94 g/cm³.

Preferably, the melting point of the polyolefin polymers as described above is less than 180° C., preferably less than 160° C. and particularly preferably is between 80 and 120° C.

Furthermore, it would not be departing from the scope of the present invention if all or part of the polyolefin segment and/or of the polyamide segment were replaced by their respective mixture with nanofillers (such as, in particular, nanoclays or carbon nanotubes), said mixtures being known by a person skilled in the art under the term of nanocomposites.

“Polyamide” or “polyamide segment” is understood to mean a polymer comprising amide functional groups. Preferably, said polyamide or polyamide segment is a condensation product:
of one or more amino acids, such as aminocaproic acid, 7-aminoheptanoic acid, 11-aminoundecanoic acid and 12-aminododecanoic acid;
of one or more lactams, such as caprolactam, oenantholactam and lauryllactam;
of one or more salts or mixtures of diamines, such as hexamethylenediamine, dodecamethylenediamine, meta-xylylenediamine, bis(p-aminocyclohexyl)methane and trimethylhexamethylenediamine, with diacids, such as isophthalic acid, terephthalic acid, adipic acid, azelaic acid, suberic acid, sebacic acid and dodecanedicarboxylic acid;
or mixtures of several of said monomers.

Preferably, said polyamide segment is chosen from the group consisting of: PA 6, PA 11, PA 12, PA 6/11 (polyamide comprising units 6 and units 11), PA 6/12 (polyamide comprising units 6 and units 12) and PA 6/6-6 (polyamide based on caprolactam, hexamethylenediamine and adipic acid).

The degree of polymerization can vary within wide proportions.

Advantageously, said polyamide segment has an end having an amine functionality.

Said polyamide segment having an amine end can be obtained using a chain limiter of formula:

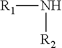

in which:

R₁ is chosen from the group consisting of hydrogen and a linear or branched alkyl group having up to 20 carbon atoms,

R₂ is chosen from the group consisting of:
a linear or branched alkyl or alkenyl radical having up to 20 carbon atoms,
a saturated or unsaturated cycloaliphatic radical,
an aromatic radical and
a combination of said radicals.

Said chain limiter can, for example, be laurylamine or oleylamine.

Advantageously, said polyamide has a molar mass Mn of between 500 and 10 000 g/mol, preferably between 1000 and 5000 g/mol and more preferably between 2000 and 3000 g/mol.

Preferably, piperazine pyrophosphate is used as flame retardant.

Within the meaning of the present invention, “flame retardant” is understood to mean compounds which make it possible to improve the resistance to fire of plastics.

The piperazine pyrophosphate can be encapsulated in a melamine-based resin. Preferably, the only flame retardant of the composition according to the present invention is based on piperazine pyrophosphate. Preferably, “flame retardant based on piperazine pyrophosphate” is understood to mean a flame retardant comprising at least 50%, preferably 60%, 70%, 80%, 90% and more preferably 95% by weight of piperazine pyrophosphate, with respect to the weight of the flame retardant.

Within the meaning of the present invention, “coloring additive” is understood to mean chemical or natural dyes, coloring pigments and brighteners. The coloring additive can, for example, be chosen from those listed in the document Colorants et Pigments [Dyes and Pigments], by Daniel Wyart, from the Techniques de l'Ingénieur [Techniques of the Engineer].

Preferably, the coloring additive is used in the masterbatch form.

Preferably, the composition according to the present invention additionally comprises a molecular sieve, preferably chosen from the group consisting of a hydrotalcite and a zeolite. Preferably, said zeolite is chosen from the group consisting of: zeolites of 3A, 4A, 5A, 10X and 13X types.

The composition according to the invention can additionally comprise at least one additive chosen from the group consisting of: an antioxidant, a UV stabilizer, a heat stabilizer, a fluidizing agent, such as silica or ethylenebisamide, a processing aid, such as calcium stearate or magnesium stearate, and inorganic fillers. Preferably, the composition according to the invention comprises from 0% to 20% by weight of additive, with respect to the total weight of the composition.

The antioxidant makes it possible to protect the plastic material from thermal attacks due to the processing method or during the life of the plastic part. Preferably, said antioxidant can be chosen from the group consisting of compounds of sterically hindered phenol type, phosphite groups and their mixture. Preferably, the composition according to the present invention comprises from 0% to 10%, preferably from 0.1% to 5%, by weight of said antioxidant, with respect to the total weight of the composition.

The UV stabilizer makes it possible to prevent yellowing of the composition, which may be due to UV (UltraViolet) radiation. Preferably, said UV stabilizer can be chosen from the group consisting of: UV absorbers, such as benzotriazole and benzophenone, and hindered amines (HALS). Preferably, the composition according to the present invention comprises from 0% to 10%, preferably from 0.1% to 5% and more preferably from 0.2% to 2% by weight of said UV stabilizer, with respect to the total weight of the composition.

According to a specific embodiment, the composition according to the present invention additionally comprises at least one maleated or nonmaleated polyolefin. The presence of polyolefins makes it possible in particular to limit the water uptake of the composition at elevated temperature, in particular in the vicinity of 85° C. Preferably, said polyolefin is chosen from the group consisting of polypropylene homopolymers and copolymers, polyethylenes, such as HDPE or LDPE, elastomeric polyolefins, in particular based on monomers having from 2 to 8 and especially from 2 to 4 carbon atoms, rubbers based on ethylene and on propylene (EPR) and copolymers having an olefinic block, such as polypropylenes having a polyethylene block.

According to another subject matter, the patent application relates to the use of a composition according to the invention in the manufacture of jacket for metal cables, of electrical parts, such as electrical connectors or electrical engineering housings, of thermal protection jackets or sleeves, of injection-molded parts for electronic equipment, such as computers and telephones, of monolayer or multilayer tubes or of bellow tubes, preferably in the manufacture of j acket for metal cables.

According to another aspect, the present invention relates to a method for the preparation of the composition as defined above, comprising the stages of:
a) optionally, preparation of the copolymer as defined above
b) mixing:
   said copolymer obtained in stage a)
   said piperazine pyrophosphate
   if appropriate, said coloring additive, and optionally a molecular sieve.

Preferably, the mixing stage is carried out in an extruder, a cokneader, an internal mixer or any other customary device for the mixing of thermoplastic polymers. Preferably, the mixing is carried out in an extruder, preferably a corotating twin-screw extruder.

Alternatively, stages a) and b) can be carried out simultaneously, preferably in an extruder.

Preferably, the grafting of said unsaturated monomer to said at least one polyolefin segment is carried out according to the processes generally known to a person skilled in the art, for example at a temperature of between 200 and 350° C., under vacuum or under an inert atmosphere, with stirring of the reaction mixture. By way of example, said grafting can be carried out by a process of reactive extrusion in the molten state or by a process in solution in a solvent.

Preferably, the copolymer can be obtained by reaction of at least one polyamide segment having an amine end with the residues of said unsaturated monomer X fixed to said at least one polyolefin segment.

The addition of said at least one polyamide segment to said at least one X-containing polyolefin segment is carried out by reaction of an amine functional group of said polyamide segment with X. Advantageously, X carries an anhydride or acid functional group; amide or imide bonds are thus created. Preferably, this addition stage is carried out in the molten state.

Preferably, this addition stage is carried out in an extruder.

Preferably, this addition stage is carried out at between 230 and 300° C. Preferably, this addition stage is carried out for between 5 seconds and 5 minutes and preferably between 20 seconds and 1 minute and corresponds to the residence time of the mixture of said at least one X-containing polyolefin segment with said at least one polyamide segment.

The yield of this addition can be evaluated by selective extraction of said at least one segment of free polyamides, that is to say those which have not reacted to form the copolymer according to the invention.

The preparation of polyamide segments according to the present invention and also their addition to an X-containing polyolefin is described in the patents U.S. Pat. Nos. 3,976,720, 3,963,799, 5,342,886 and FR 2 291 225.

According to another aspect, the present invention relates to electronic, electrical or thermal protection components comprising the composition as defined above. These components can be chosen in particular from the group consisting of jackets for metal cables, of electrical parts, such as electrical connectors or electrical engineering housings, electronic components of computers or of telephones and thermal protection jackets and sleeves.

### EXAMPLES

### 1) Process for the Preparation of the Compositions

The formulations described in detail in table 1 below were prepared from the different ingredients mentioned below using an extruder of Leistriz model LSM30.34 type. It is a self-cleaning engaging corotating twin-screw extruder with a diameter of 34 mm and a length corresponding to 32 times its diameter. The screws are temperature-regulated according to a flat profile at 220° C. A rotational speed of 200 rpm and a throughput of 15 kg/h are displayed. The rods are subsequently extruded, cooled in a water tank and finally granulated.

Bondine HX8290, Lotader 5500 and Lotader 4210 are terpolymers of ethylene, of alkyl acrylate and of maleic anhydride sold by the applicant company.

EVA 2403 is a copolymer of ethylene and of vinyl acetate having an MFI (190° C., 2.16 kg) of 3 g/10 min and a content by weight of vinyl acetate of 24%.

The PA6 (polyamide 6) prepolymer is a PA6 having a number-average molecular weight of 2500 g/mol and terminated by a single primary amine functional group.

Siliporite NK10AP is a zeolite of 4A type produced by CECA.

Irganox 1010 is a primary antioxidant produced by BASF.

Alkanox 240 is a secondary antioxidant produced by Chemtura Great Lakes.

Budit 3178 is a flame retardant based on ammonium polyphosphate produced by Budenheim.

ADK STAB FP2500S is a flame retardant based on piperazine pyrophosphate sold by ADK.

PE48/5/4025F is a blue masterbatch produced by Colloids.

Compositions 5 and 6 constitute counterexamples.

### 2) Protocol Used to Measure the Elongation at Break, the Aging and the Fire Properties (UL94 and LOI)

The granules resulting from the preparation stage are subsequently formed according to the following methods:
Injection molding on a molding machine of Battenfeld type having a clamping force of 80 t at a temperature of 230° C. in a mold thermally regulated at 30° C. and according to an injection flow rate of 30 cm³/s.
Extrusion of films (thickness of 500 μm) at 210° C. by virtue of a twin-screw extruder comprising conical counterrotating screws of Haake Rheocord 40 type provided with a flat die with a thickness of 1 mm and a width of 10 cm.

Standardized test specimens are thus formed according to the following international standards:
Elongation at break: Test specimens of IFC (Institut Francais du Caoutchouc [French Institute of Rubber]) type cut out with a hollow punch from the films extruded on the Haake
Test according to UL94: Injection-molded test specimens with a size of 127 mm×12.7 mm and having a thickness of 1.6 mm
Test according to LOI: Injection-molded test specimens with a size of 127 mm×12.7 mm and having a thickness of 3.2 mm.

The thermal aging conditions are as follows: The IFC test specimens cut out with a hollow punch are placed for a certain time in a temperature-regulated air circulation oven.

TABLE 1

| Composition | 1 | 2 | 3 | 4 | 5 | 6 | 7 | 8 | 9 | 10 | 11 |
|---|---|---|---|---|---|---|---|---|---|---|---|
| Bondine HX8290 | 42.7 | 39.2 | 48.8 | 12.81 | 42.7 | | 46.2 | 43.89 | 48.8 | 42.7 | 58.8 |
| Lotader 5500 | | | | | | 42.7 | | | | | |
| Lotader 4210 | | | | 29.89 | | | | | | | |
| EVA 2403 | 10 | 10 | 10 | 10 | 10 | 10 | | | 10 | 10 | 10 |
| PA6 prepolymer | 18.3 | 16.8 | 12.2 | 18.3 | 18.3 | 18.3 | 19.8 | 18.81 | 12.2 | 18.3 | 14.7 |
| Siliporite NK10AP | 2 | 2 | 2 | 2 | 2 | 2 | 2 | 1.9 | 2 | 2 | 2 |
| Irganox 1010 | 1.5 | 1.5 | 1.5 | 1.5 | 1.5 | 1.5 | 1.5 | 1.425 | 1.5 | 1.5 | 1.5 |
| Alkanox 240 | 0.5 | 0.5 | 0.5 | 0.5 | 0.5 | 0.5 | 0.5 | 0.475 | 0.5 | 0.5 | 0.5 |
| Budit 3178 | | | | | 25 | 25 | | | | | |
| ADK STAB | 25 | 30 | 25 | 25 | | | 30 | 28.5 | 25 | 25 | 12.5 |
| FP-2500S | | | | | | | | | | | |
| PE48/5/4025F | | | | | | | | 5 | | | |
| Total | 100 | 100 | 100 | 100 | 100 | 100 | 100 | 100 | 100 | 100 | 100 |

The characteristics are measured as follows:

Elongation at break obtained after tensile testing of the IFC test specimens at a rate of 50 mm/min 23° C. on a Zwick universal testing machine.

The flame propagation test is carried out according to the standard UL94 on injection-molded test specimens.

The material tested is classified as V0 if:

A) None of the five samples burns for more than 10 seconds after the flame of the burner has been removed.

B) The total combustion time over the 10 tests does not exceed 50 seconds.

C) None of the samples tested burns, either with a flame or by glowing, as far as the holding jaw.

D) No glowing drop, which can ignite the cotton cloth placed below, falls from any sample.

E) No sample exhibits a glowing time exceeding 30 seconds.

The material tested is classified as V1 if:

A) None of the five samples burns for more than 30 seconds after the flame of the burner has been removed.

B) The total combustion time over the 10 tests does not exceed 250 seconds.

C) None of the samples tested burns, either with a flame or by glowing, as far as the holding jaw.

D) No glowing drop, which can ignite the cotton cloth placed below, falls from any sample.

E) No sample exhibits a glowing time exceeding 60 seconds.

The material tested is classified as V2 if:

A) None of the five samples burns for more than 30 seconds after the flame of the burner has been removed.

B) The total combustion time over the 10 tests does not exceed 250 seconds.

C) None of the samples tested burns, either with a flame or by glowing, as far as the holding jaw.

D) A few fragments may become detached from the sample tested, burning temporarily, and some of which may ignite the cotton cloth placed below.

E) No sample exhibits a glowing time exceeding 60 seconds.

In all the other cases, the material is unclassified.

The Limiting Oxygen Index (LOI) test is carried out according to the standard ASTM D2863 on injection-molded test specimens.

### 3 Results

3.1. Coloration after 10 d at 175° C., Elongation at t₀ and Fire Properties

TABLE 2

| | Color | | Elongation | | |
|---|---|---|---|---|---|
| | before | After 240 h | at t₀ | | LOI |
| | aging | at 175° C. | [%] | UL94 | [%] |
| Composition | Beige | Beige | 200 | V1 | 35 |
| 1 | | | | | |
| Composition | Beige | Beige | 103 | V0 | 37 |
| 2 | | | | | |
| Composition | Beige | Beige | 250 | V1 | 34 |
| 3 | | | | | |
| Composition | Beige | Beige | 165 | V1 | 35 |
| 4 | | | | | |
| Composition | Beige | Black | 280 | V0 | 37 |
| 5 | | | | | |
| Composition | Beige | Black | 320 | V0 | 37 |
| 6 | | | | | |
| Composition | Beige | Beige | 80 | V1 | 37 |
| 7 | | | | | |
| Composition | Blue | Green | 90 | V1 | 37 |
| 8 | | | | | |
| Composition | Beige | Beige | 300 | V1 | 34 |
| 9 | | | | | |
| Composition | Beige | Beige | 230 | V1 | 35 |
| 10 | | | | | |
| Composition | Beige | Beige | >250 | Unclassified | ND |
| 11 | | | | | |

3.2. Comparison of the Elongation at Break Before and after Aging

The elongation at break was measured before and after aging for compositions 6 to 11. The results are reported in Table 3 below.

TABLE 3

| | Elongation at | Elongation at break | |
|---|---|---|---|
| | break at t₀ | after 240 h at 175° C. | Difference |
| | [%] | [%] | [%] |
| Composition | 320 | 240 | −25 |
| 6 | | | |
| Composition | 80 | 70 | −10 |
| 7 | | | |
| Composition | 90 | 70 | −20 |
| 8 | | | |
| Composition | 300 | 170 | −45 |
| 9 | | | |
| Composition | 230 | 90 | −60 |
| 10 | | | |

The materials according to the invention exhibit satisfactory performance qualities for the targeted applications (initial elongation at break, retention of these elongations at break after aging tests for 240 hours at 175° C., flame retardancy according to flame propagation test UL94 and Limiting Oxygen Index). On the other hand, unlike the counterexamples based on ammonium polyphosphate, only the examples based on piperazine pyrophosphate have the property of remaining distinguishable in color after a thermal oxidation aging for 240 hours at 175° C.

### 3.3. Fire-On-Cable Test

The fire-on-cable resistance was measured on two samples obtained by coating a cable with a diameter of 1.7 mm and 1.9 mm respectively with a layer with a thickness of 0.3 mm of compositions 3 and 11.

The tests were carried out on a test bench equipped with a propane gas burner and provided with a 45° support at a temperature of 23° C. without air displacement. Five samples of cable based on compositions 3 and 11 with a length of 600 mm each were positioned on the support, so as to be inclined by 45° with respect to the horizontal, and then exposed for a duration of 30 seconds to the flame of the burner forming a right angle with the sample and targeting the lower end of the cable (length of the flame: 100 mm, with a blue inner cone of 50 mm with a temperature of 990° C.). After removal of the flame, the combustion time and also the length of insulator which has remained intact are measured.

The test is regarded as positive when:
combustion is continued for a duration of less than 70 seconds after the removal of the flame; and when
the upper end of the cable tested has remained intact over, at a minimum, a length of 50 mm.

The results of the tests on the samples are reported in Table 4 below.

TABLE 4

| | Extinguishing time | Intact length of the cable |
|---|---|---|
| | [s] | [mm] |
| Composition | 0 | 470 |
| 3 | | |
| Composition | 20 | 400 |
| 11 | | |

These results reveal that the material according to the invention exhibits satisfactory performance qualities in terms of resistance to fire, including when it is present in a small amount.

1. A composition comprising:
a copolymer comprising at least one segment of a polyolefin and at least one segment of a polyamide, said polyamide having a molar mass Mn of between 500 and 10 000 g/mol,
piperazine pyrophosphate,
optionally a coloring additive, and
optionally a molecular sieve.

2. The composition as claimed in claim 1, comprising:
a copolymer comprising at least one polyolefin segment and, on average, at least one segment of a polyamide attached to said at least one segment of a polyolefin by the residues of at least one unsaturated monomer (X),
piperazine pyrophosphate,
optionally a coloring additive, and
optionally a molecular sieve.

3. The composition as claimed in claim 1, wherein the composition does not comprise a halogenated compound.

4. The composition as claimed in claim 1, wherein said polyolefin is chosen from ethylene/maleic anhydride and ethylene/alkyl (meth)acrylate/maleic anhydride copolymers.

5. The composition as claimed in claim 1, wherein said copolymer comprises, on average, at least 1.3 mol of residues of the unsaturated monomer (X) attached to said polyolefin segment per mole of polyolefin segment.

6. The composition as claimed in claim 1, wherein said polyamide has a molar mass Mn of between 1000 and 5000 g/mol.

7. The composition as claimed in claim 1, additionally comprising a molecular sieve.

8. The composition as claimed in claim 1, wherein piperazine pyrophosphate is the only flame retardant.

9. The composition as claimed in claim 1, comprising from 5% to 50% by weight of said piperazine phosphate, with respect to the total weight of the composition.

10. The composition as claimed in claim 1, additionally comprising at least one polyolefin which may be maleated or nonmaleated.

11. The composition as claimed in claim 1, not comprising a coloring additive.

12. An article of manufacture comprising a composition as claimed in claim 1, where the article of manufacture is a jacket for metal cables, of electrical parts, a thermal protection jackets or sleeves, injection-molded parts for electronic equipment, monolayer or multilayer tubes, or bellow tubes.

13. A method for the preparation of a composition as claimed in claim 1, comprising:
a) preparation of said copolymer;
b) mixing:
the copolymer obtained in stage a);
said piperazine pyrophosphate;
optionally, said coloring additive; and
optionally, a molecular sieve.

14. The method as claimed in claim 13, in which stages a) and b) are carried out simultaneously.

15. Electronic, electrical or thermal protection components comprising the composition as defined in claim 1.
